(19) United States
(12) Patent Application Publication
(10) Pub. No.: US 2003/0126140 A1
(43) Pub. Date: Jul. 3, 2003

(54) Method, system, and computer program product for generating custom databases

(75) Inventors: Kathryn Engelhardt-Cronk, Austin, TX (US); David Ashley, Round Rock, TX (US)

Correspondence Address: HAYNES AND BOONE, LLP, 600 CONGRESS AVENUE, SUITE 1600, AUSTIN, TX, 78701, US

(73) Assignee: Community TechKnowledge, Inc., Austin, TX

(21) Appl. No.: 10/034,090

(22) Filed: Dec. 28, 2001

(51) Int. Cl. G06F 7/00

(52) U.S. Cl. 707/100

(57) ABSTRACT

This invention relates to a method, a system and a computer program product for generating custom databases. It is emphasized that this abstract is provided to comply with the rules requiring an abstract that will allow a searcher or other reader to quickly ascertain the subject matter of the technical disclosure; and is submitted with the understanding that it will not be used to interpret or limit the scope or meaning of the claims under 37 CFR 1.72.

The disclosures herein relate to a method, a system, and a computer program product for generating custom databases.

### BRIEF DESCRIPTION OF THE DRAWINGS

FIG. 1a is a diagram illustrating an embodiment of a system for generating custom databases.

FIG. 1b is a diagram illustrating an embodiment of a computer system.

FIG. 2a is an illustration of a first screen displayable by a display device of the system of FIG. 1.

FIG. 2b is an illustration of a second screen displayable by a display device of the system of FIG. 1.

FIG. 2c is an illustration of a third screen displayable by a display device of the system of FIG. 1.

FIG. 2d is an illustration of a fourth screen displayable by a display device of the system of FIG. 1.

FIG. 2e is an illustration of a fifth screen displayable by a display device of the system of FIG. 1.

FIG. 2f is an illustration of a sixth screen displayable by a display device of the system of FIG. 1.

FIG. 2g is an illustration of a seventh screen displayable by a display device of the system of FIG. 1.

FIG. 2h is an illustration of a eighth screen displayable by a display device of the system of FIG. 1.

FIG. 2i is an illustration of a ninth screen displayable by a display device of the system of FIG. 1.

FIG. 2j is an illustration of a tenth screen displayable by a display device of the system of FIG. 1.

FIG. 2k is an illustration of a eleventh screen displayable by a display device of the system of FIG. 1.

FIG. 2l is an illustration of a twelfth screen displayable by a display device of the system of FIG. 1.

FIG. 2m is an illustration of a thirteenth screen displayable by a display device of the system of FIG. 1.

FIG. 2n is an illustration of a fourteenth screen displayable by a display device of the system of FIG. 1.

FIG. 2o is an illustration of a fifteenth screen displayable by a display device of the system of FIG. 1.

FIG. 3a is an embodiment of a flowchart illustrating a method for creating and generating custom databases.

FIG. 3b is an embodiment of a flowchart illustrating a method for generating custom databases.

FIG. 4a is an illustration of a sixteenth screen displayable by a display device of the system of FIG. 1.

FIG. 4b is an illustration of a seventeenth screen displayable by a display device of the system of FIG. 1.

FIG. 4c is an illustration of a eighteenth screen displayable by a display device of the system of FIG. 1.

FIG. 4d is an illustration of a nineteenth screen displayable by a display device of the system of FIG. 1.

FIG. 4e is an illustration of a twentieth screen displayable by a display device of the system of FIG. 1.

FIG. 4f is an illustration of a twenty first screen displayable by a display device of the system of FIG. 1.

FIG. 4g is an illustration of a twenty second screen displayable by a display device of the system of FIG. 1.

FIG. 4h is an illustration of a twenty third screen displayable by a display device of the system of FIG. 1.

FIG. 4i is an illustration of a twenty fourth screen displayable by a display device of the system of FIG. 1.

### DETAILED DESCRIPTION

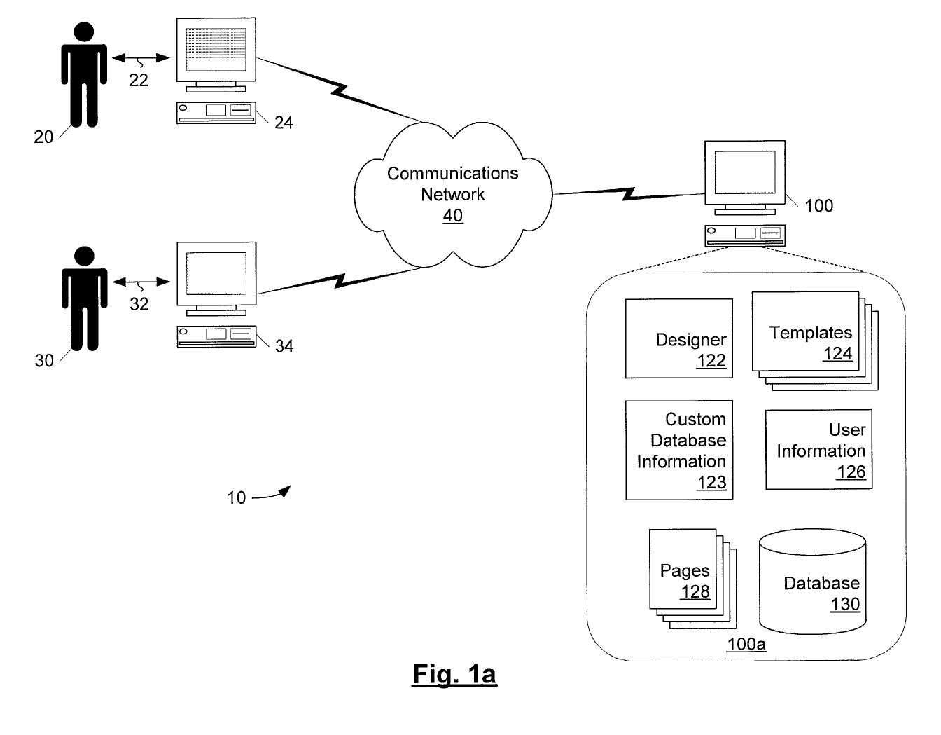

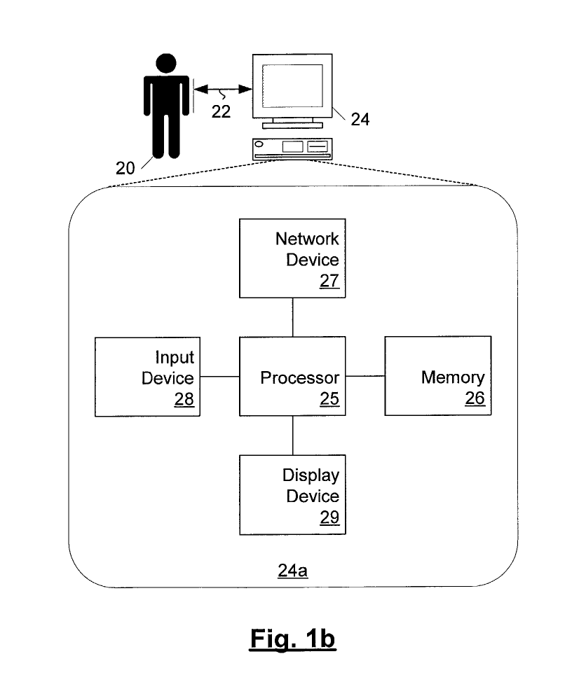

Referring to FIG. 1a of the drawings, a system 10 for generating custom databases is illustrated. A user 20 provides inputs to and receives outputs from a computer system 24 as indicated by an arrow 22. A user 30 provides inputs to and receives outputs from a computer system 34 as indicated by an arrow 32. Computer systems 24 and 34 communicate with a server 100 using a communications network 40.

Server 100 includes a designer 122, custom database information 123, a set of templates 124, user information 126, a set of pages 128, and a database 130. Designer 122 is a program configured to provide users 20 and 30 with an ability to create, modify, and manage custom databases. Designer 122 may be stored in any suitable storage device or other apparatus accessible by server 100 such as a RAM, a hard disk drive, a CD-ROM, a DVD, a DAT, or a floppy disk.

Using inputs received from user 20 or user 30 and stored as custom database information 123, designer 122 causes pages 128 and database 130 to be generated as will be described in additional detail herein below. Pages 128 and database 130 comprise a custom database. Designer 122 also provides user 20 and/or user 30 with an ability to modify and re-generate the custom database as desired by user 20 or user 30.

After creating pages 128 and database 130, designer 122 stores pages 128 and database 130 in one or more locations. These locations may be located on server 100 as shown in FIG. 1a or on another computer system accessible using communications network 40. Designer 122 may create one or more directories for storing pages 128 and database 130 and may create these directories in a location specified by user 20 or user 30. For example, user 20 may provide a URL, such as http://www.myagency.org, where the custom database may be accessed. In this example, user 20 or user 30 may access the custom database by providing the URL http://www.myagency.org to a browser, such as Netscape Navigator or Microsoft Internet Explorer, or other suitable program.

Pages 128 include code and/or other information stored in a format to cause information to be displayed on a display device of computer system 24 and/or 34 using a browser or other suitable program. Pages 128 also include code and/or other information for causing information to be stored into, retrieved from, or deleted from database 130. In addition, pages 128 may optionally include code and/or other information to allow other functions to be performed in conjunction with the custom database. For example, these functions may include a login function, a calendar function, a library function, a bulletins function, navigation functions, and other administrative functions. Database 130 includes information stored as part of the database.

In the embodiment of FIG. 1a, designer 122 generates pages 128 using PHP, HTML, and DHTML code and creates database 130 using MySQL. In other embodiments, designer 122 causes pages 128 and database 130 to be generated using other types of code.

To create pages 128 and database 130, designer 122 causes information associated with a custom database to be received from user 20 and/or user 30. This information is stored as custom database information 123. Designer 122 stores information into, retrieves information from, or deletes information from custom database information 123 in response to information received from user 20 and/or user 30. The information received from user 20 and/or user 30 specifies or changes one or more characteristics of the custom database as will be described in additional detail herein below.

Designer 122 uses templates 124 to assist user 20 and/or user 30 in creating or modifying a custom database. Each template 124 includes a set of predefined database tables, forms, sections, and/or fields. Templates 124 may each include a collection of common or logically related tables, forms, sections, and/or fields as will be described in additional detail herein below. Designer 122 provides user 20 and/or user 30 with an ability to select one or more of templates 124 for inclusion in the custom database. Designer also providers user 20 and/or user 30 with an ability to modify one or more of templates 124.

User information 126 includes login and password information regarding users such as users 20 and 30. Designer 122 uses information in user information 126 to authenticate users and to determine which custom databases a user may access.

Communications network 40 may be any wired or wireless network configured to allow computer systems 24 and 34 to communicate with server 100. For example, communication network 40 may be a global communications network such as the Internet, an intranet, a wide area network (WAN), a local area network (LAN), or a point-to-point connection. Computer systems 24 and 34 may communicate with server 100 using secure sockets layer (SSL) encryption or other encryption technology. In addition, server 100 may operate using a firewall program to regulate access to information stored on server 100.

Computer systems 24 and 34 may each be any suitable computing device configured to communicate with server 100 using communications network 40. For example, computer systems 24 and 34 may each be a personal computer, a laptop computer, a digital or cellular telephone, a personal digital assistant (PDA), or any other suitable of computing device.

Additional details of an embodiment of computer system 24 are shown in FIG. 1b. As indicated by a box 24a, computer system 24 includes a processor 25, a memory 26, a network device 27, an input device 28, and a display device 29. Processor 25 executes instructions from programs (not shown) stored in memory 26. Memory 26 may include one or more memory devices such as random access memory (RAM) and/or hard disk drives. These memory devices may be arranged in a hierarchical manner. Memory 26 may include a communications program (not shown) such as an Internet browser.

Processor 25 operates in conjunction with network device 27 to send information to server 100 and receive information from server 100 using communications network 40. Network device 27 may be any suitable wired or wireless network device or devices configured to communicate using communications network 40. For example, network device 27 include a network interconnect (NIC), a telephone or cable modem, or a wireless transmitter and receiver.

Processor 25 operates in conjunction with input device 28 and display device 29 to receive inputs from user 20 and to provide outputs to user 20, respectively. Input device 28 may be any suitable wired or wireless input device or devices configured to allow user 20 to provide inputs to computer system 24. For example, input device 28 may include a keyboard, a mouse, and/or a touch pad. Display device 29 may be any suitable device configured to provide outputs to user 20. For example, display device 29 may include a computer monitor, a television, or panel display.

Although shown in FIG. 1b as being integrated into computer system 24, memory 26, network device 27, input device 28, and/or display device 29 may be located externally from the computer system 24. Computer system 34 may include components similar to those of computer system 24.

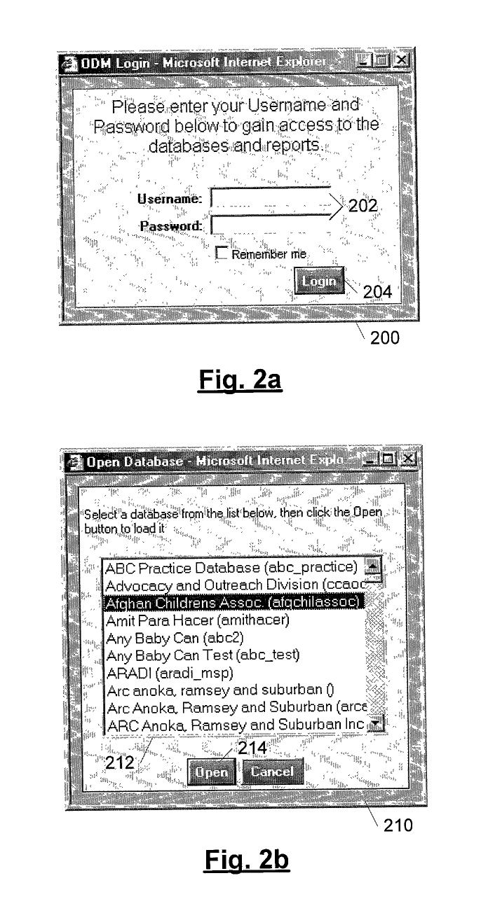

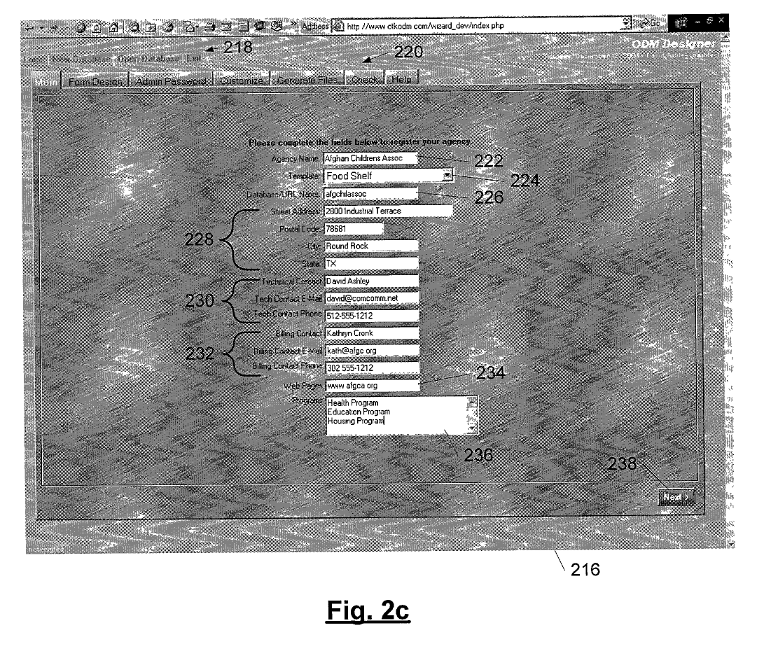

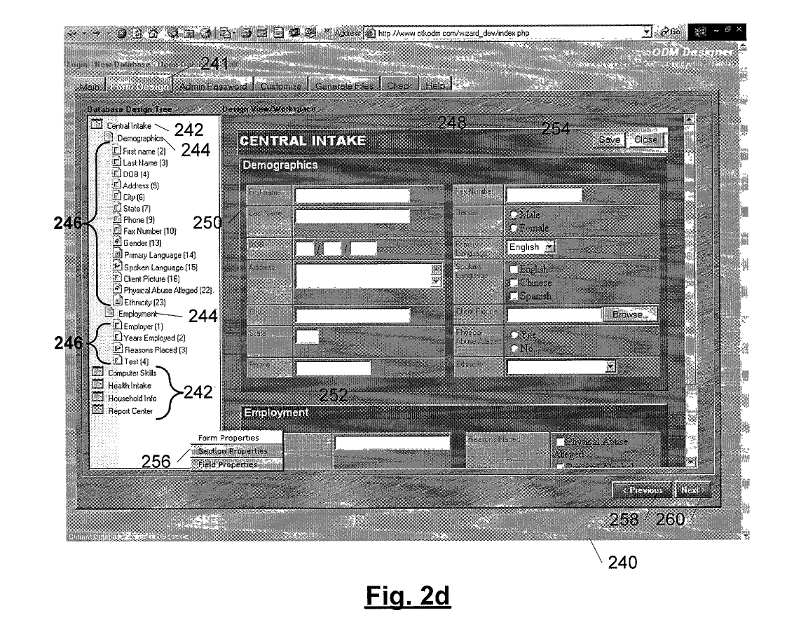

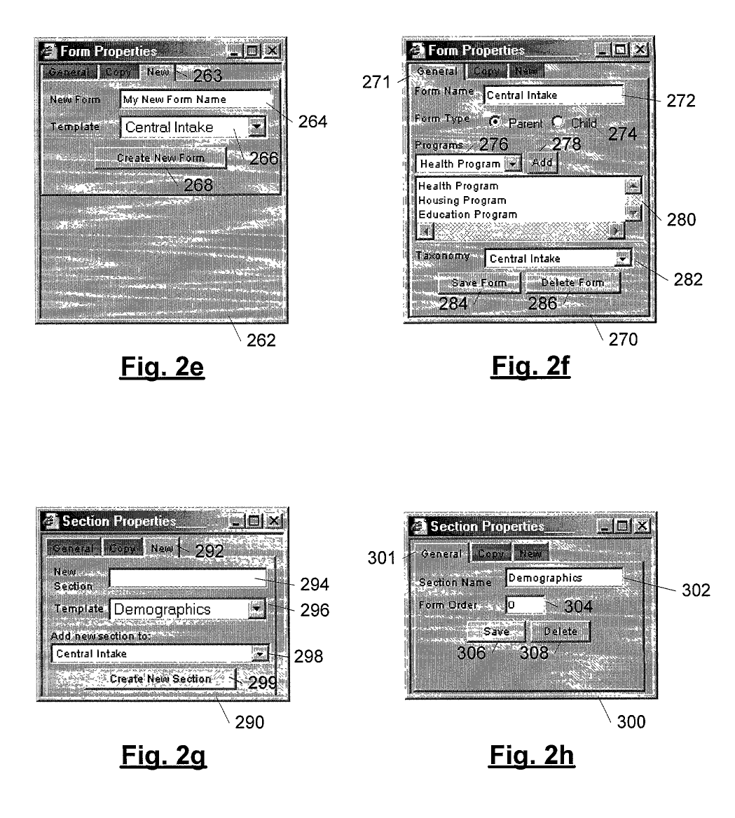

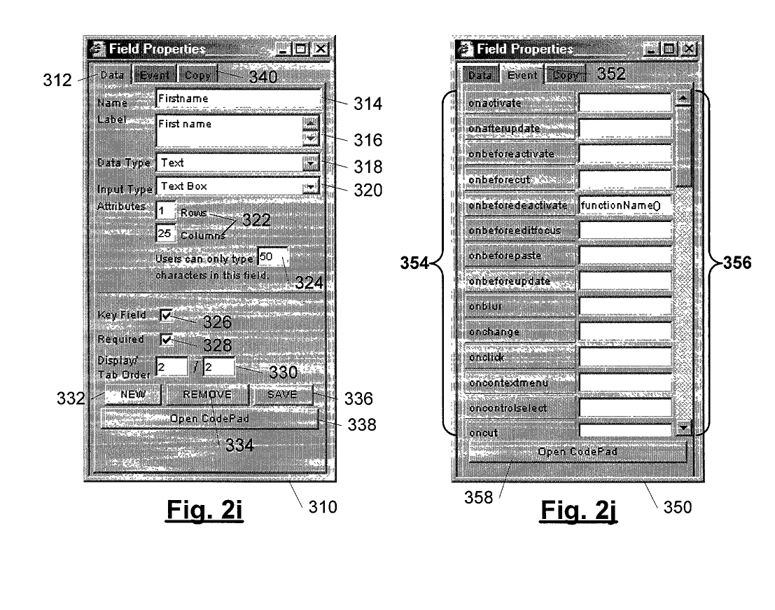

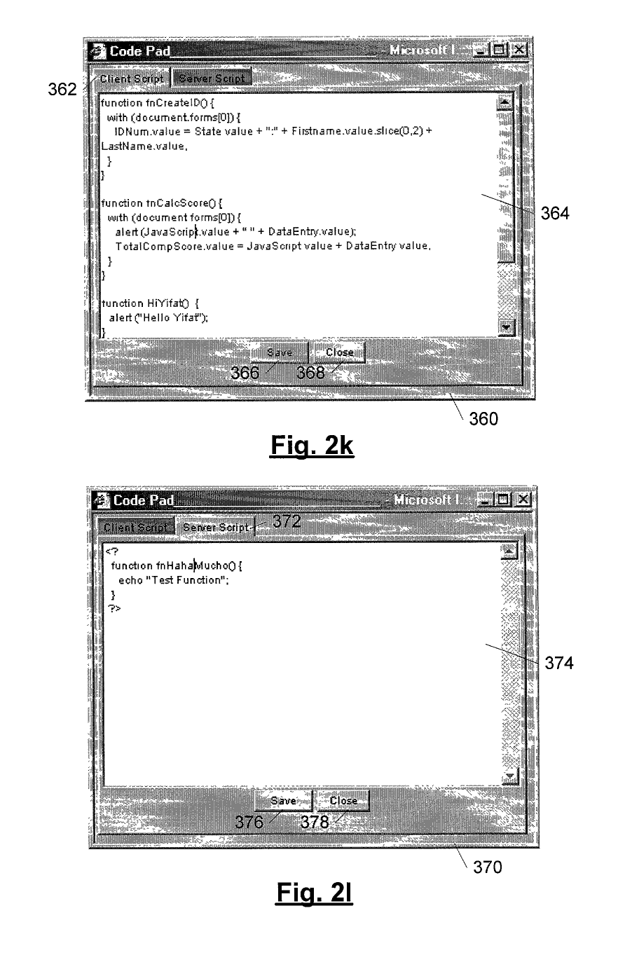

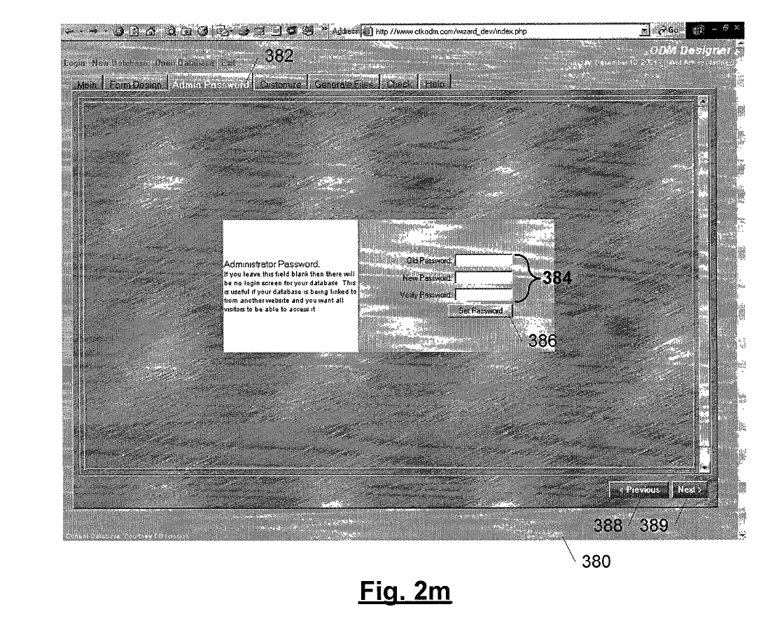

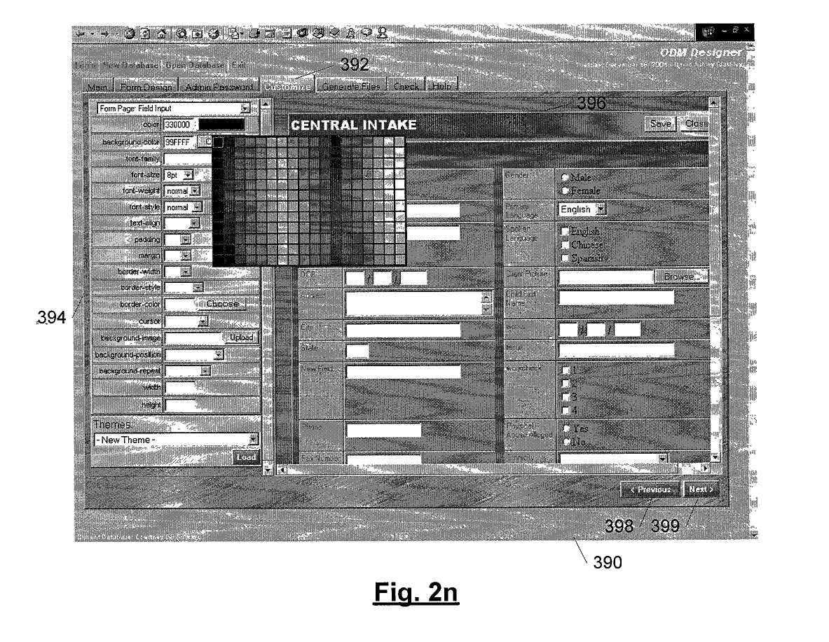

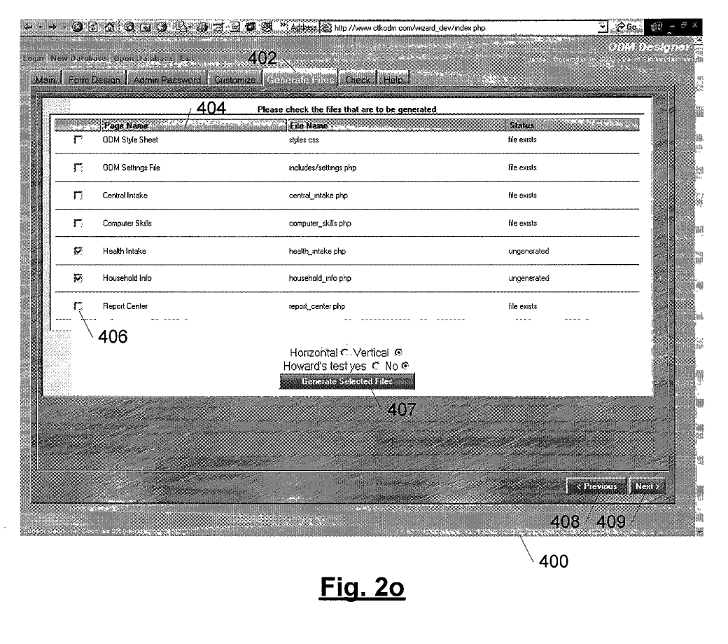

Designer 122 provides user 20 and/or user 30 with an ability to create and modify a custom database. This ability is described with reference to FIGS. 2a through 2o which illustrate screens provided (or output) by server 100 to computer system 24 or 34 in response to instructions from designer 122. In response to receiving the screens, computer system 24 or 34 displays the screens using display device 29 or 39, respectively. Although the screens shown in FIGS. 2a through 2o represent a browser or window format, the screens may be modified to other types of formats to suit other types of computing devices such as those listed herein above.

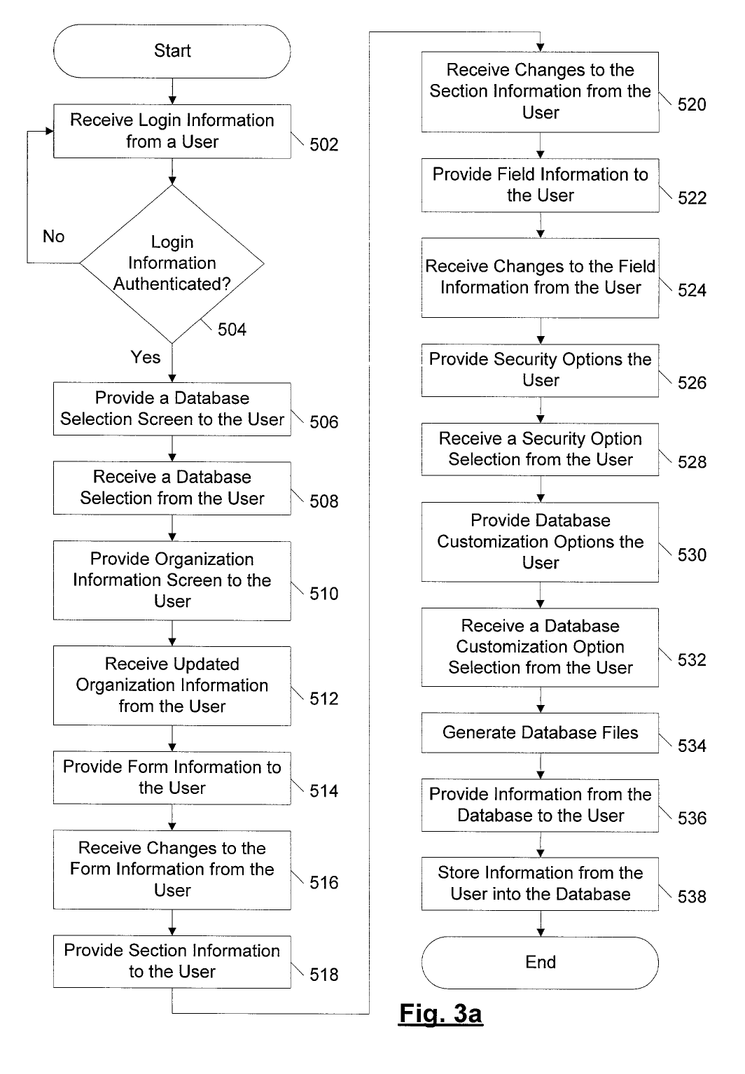

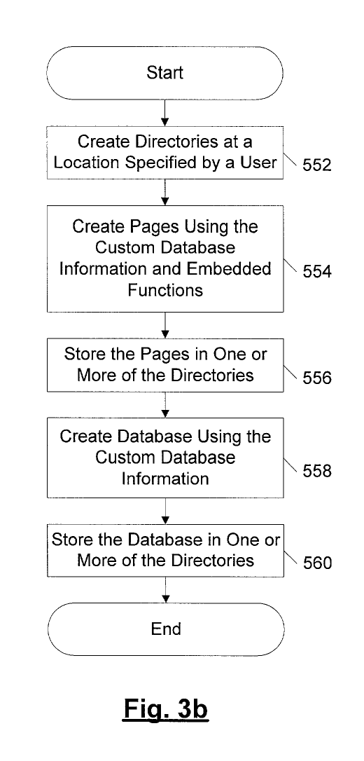

FIGS. 2a through 2o will be described in conjunction with the system shown in FIG. 1a and the flowchart shown in FIG. 3a. For convenience, the description herein below will refer to user 20 and computer system 24 where input device 28 of computer system 24 includes a keyboard and a mouse and display device 29 includes a computer monitor.

User 20 accesses designer 122 by entering a URL into a browser. In response to being accessed by user 20, designer 122 causes a login screen 200, shown in FIG. 2a, to be provided to user 20. User 20 enters a username and password into boxes 202 and selects a “Login” button 204 to cause login information to be sent to designer 122. The login information may be entered in by user 20 or otherwise stored on computer system 24.

In response to receiving login and password information from user 20 as shown in step 502 in FIG. 3a, designer 122 accesses user information 126 to attempt to authenticate user 20 as indicated in step 504. If user 20 is authenticated, then designer 122 provides user 20 with an ability to create or modify a custom database. If user 20 is not authenticated, then designer 122 again provides login screen 200 to user 20.

After user 20 is authenticated, designer 122 provides user 20 with access to a custom database associated with user 20. If user 20 is not authenticated, designer 122 prevents user 20 from the custom database. If user 20 is a new user, designer 122 may provide user 20 with an ability to create a new account. To do so, designer 122 causes login and password information to be received from user 20 and stores the login and password information in user information 126.

FIG. 2b illustrates a database selection screen 210. After user 20 logs in and is authenticated by designer 122, designer 122 provides database selection screen 210 to user 20 as indicated in step 506. The database selection screen 210 provides user 20 with an ability to select a previously created database for editing by highlighting a database from a list of previously created databases shown in a box 212 and selecting an “Open” button 214. The list of previously created databases provided to user 20 are those databases associated with user 20. In other words, user 20 is provided with the ability to select only those databases with which user 20 has a right or a need to access. For example, user 20 may be an administrator or other employee of XYZ Agency and may be provided with access to all or selected databases associated with XYZ Agency. User 20 may also opt to create a new database.

In response to user 20 selecting a database to open, information associated with the selection is transmitted by computer 24 using communications network 40 and received by server 100 as indicated in step 508. Designer 122 then causes an organization information screen 216, as illustrated in FIG. 2c, to be provided to user 20 as shown in step 510. Screen 216 includes links 218 to allow user 20 to select a function such as logging in (“Login”), opening a new database (“New Database”), opening a different database (“Open Database”), or exiting (“Exit”). Screen 216 also includes tabs 220 to allow user 20 to navigate between various functions of designer 122.

In the organization information screen 216, user 20 enters information associated with the an organization with which pages 128 and database 130 is associated. The information includes an agency name in a box 222, a template selection 224, a database/URL name 226, address information 228, technical contact information in boxes 230, billing contact information in boxes 232, a website address associated with the database in a box 234, and a list of programs administered by the agency in a box 236. Designer 122 causes the information entered by user 20 to be stored in custom database information 123.

The template selection 224 includes a list of database templates from templates 124 that are selectable by user 20. Each database template from templates 124 includes one or more predefined forms that include predefined sections and/or fields. As will be described in additional detail below, designer also provides user 20 with an ability to select individual form or section templates from templates 124 for inclusion in the custom database.

The website address entered in box 234 is the location where user 20 will access the custom database after it is created. After generating the custom database as will be described in additional detail herein below, designer 122 stores the custom database in a location such that user 20 accesses the custom database using the website address.

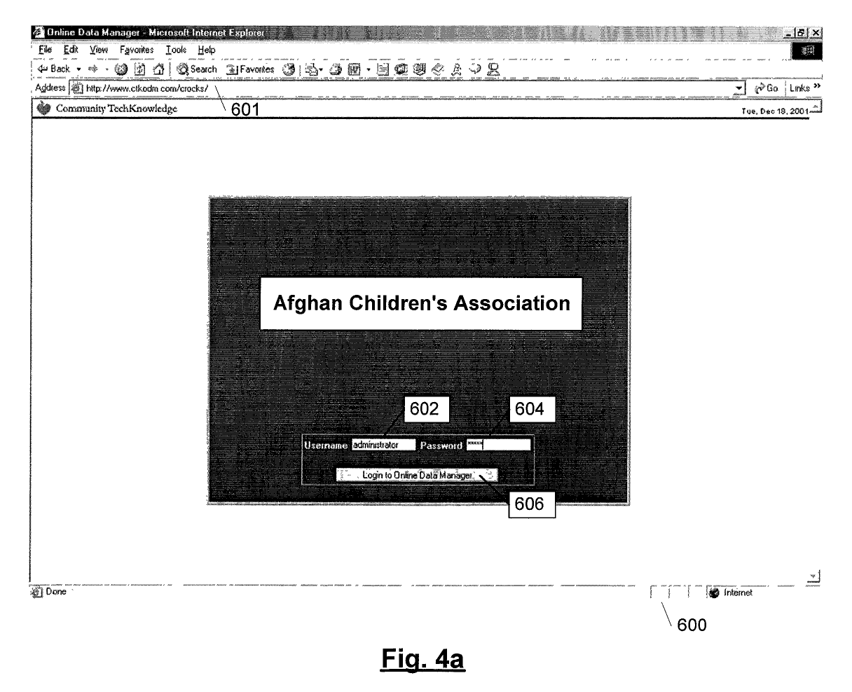

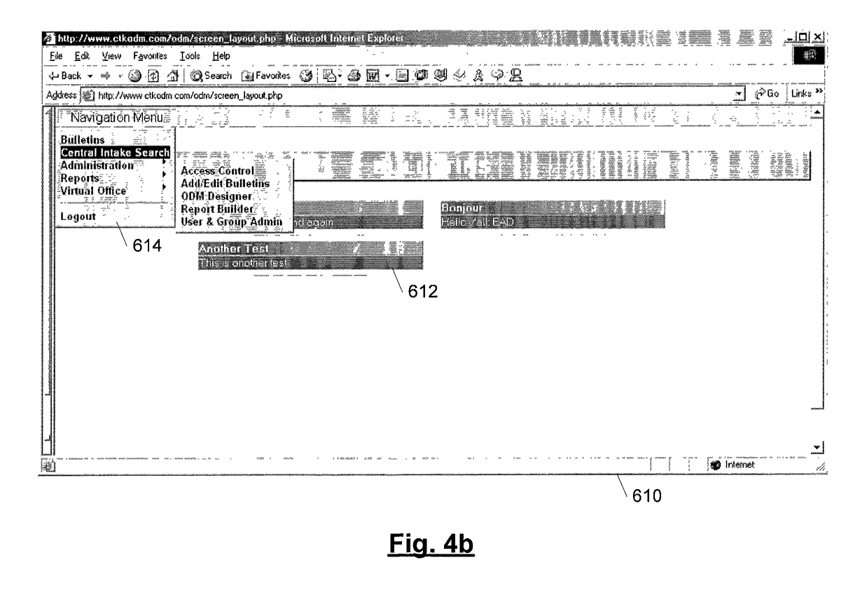

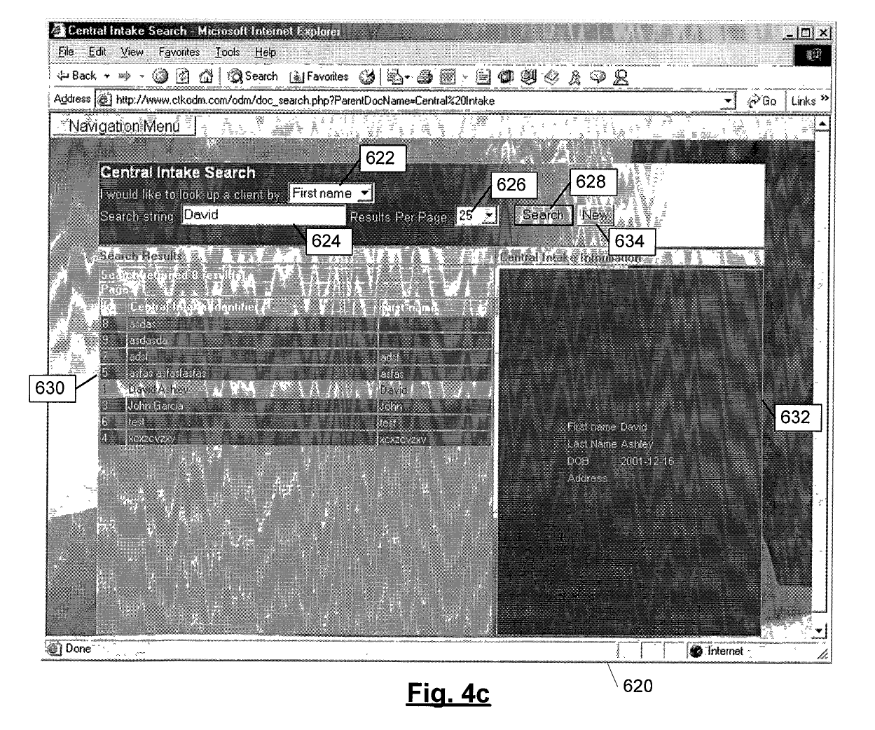

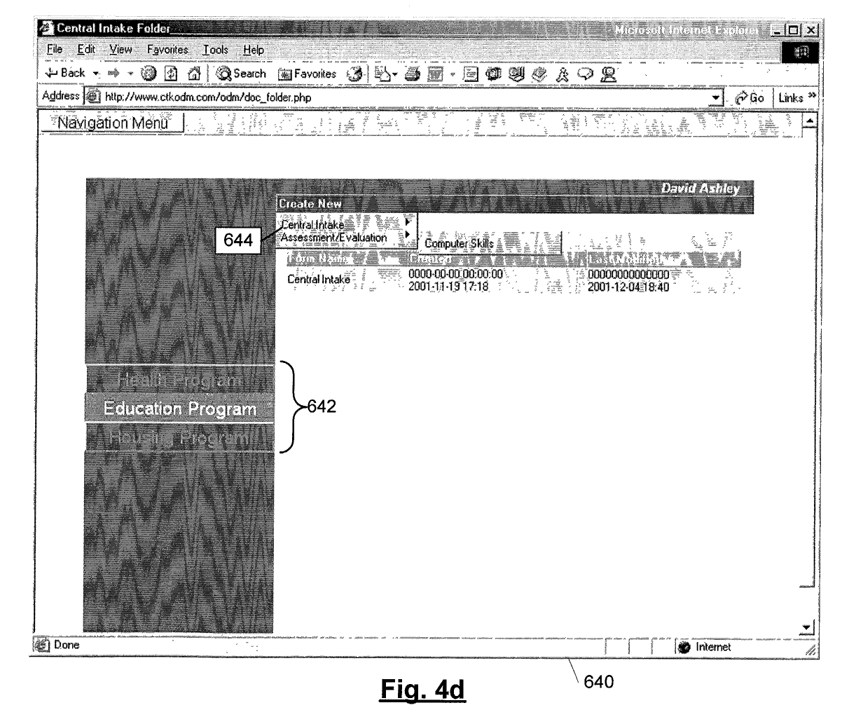

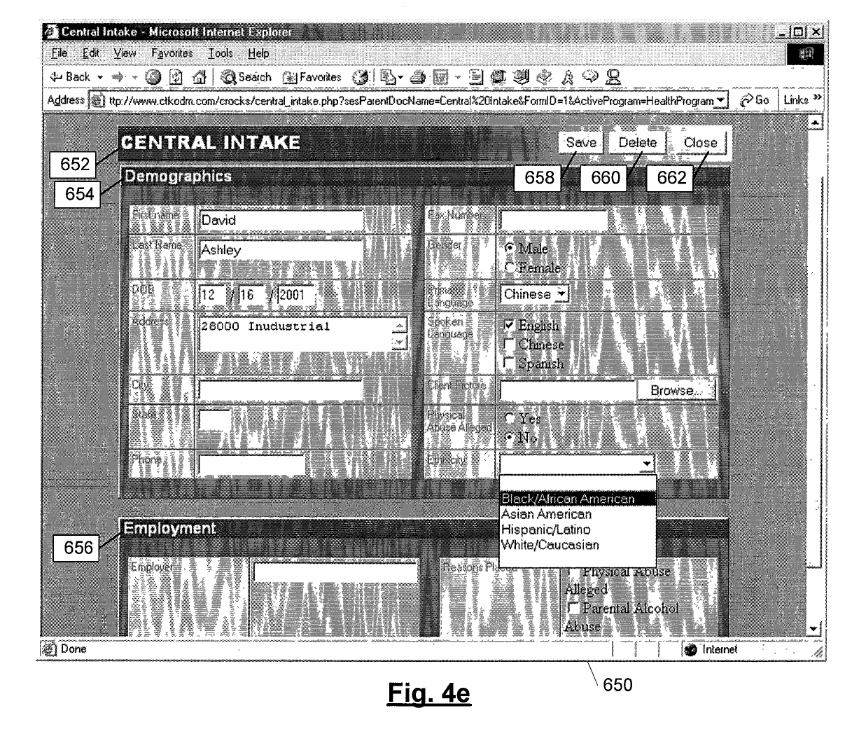

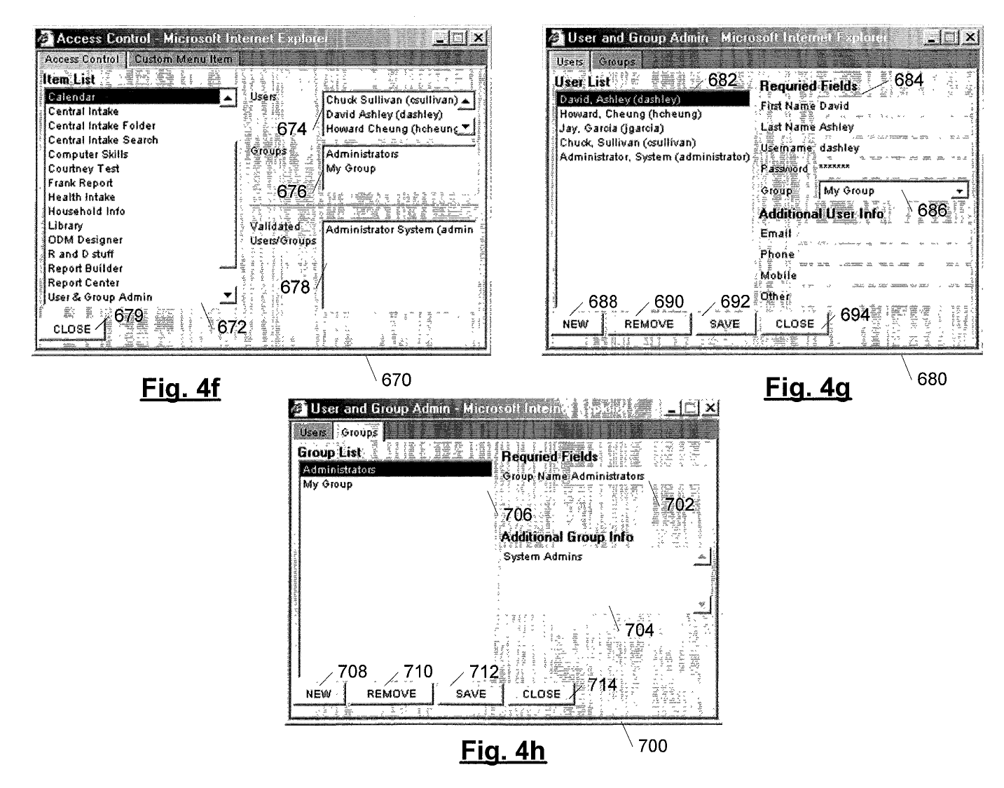

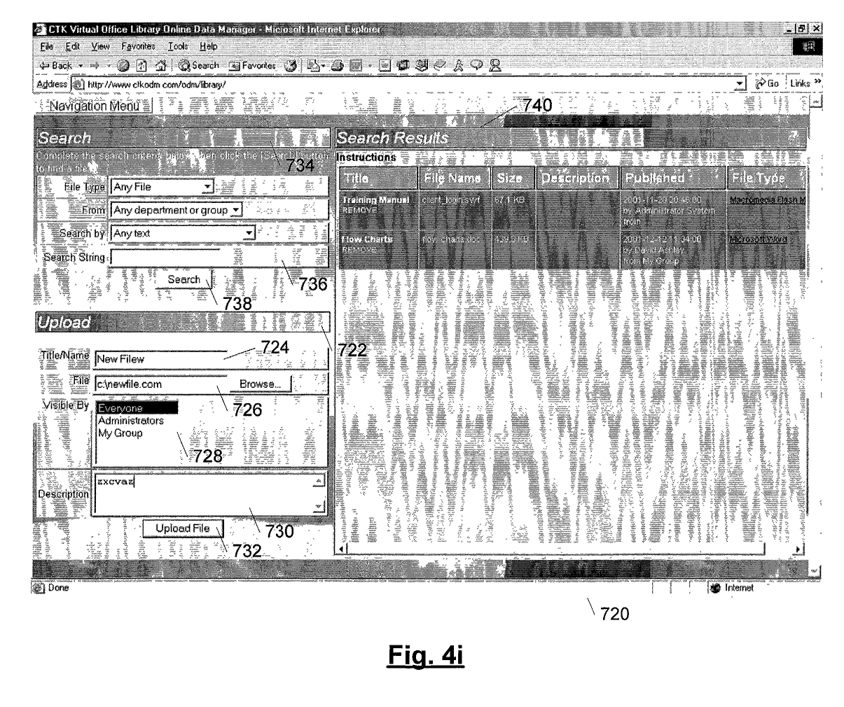

Each program entered by user 20 in box 236 may define an administrative category of an agency such as a department. The programs listed in box 236 will appear in a client folder screen as shown herein below in FIG. 4d. User 20 may add programs by adding a program name to box 236 or may remove programs by deleting a program name from box 236.

Although not shown in screen 216, designer 122 may provide user 20 with an ability to select between multiple database programs. Designer 122 may create pages 128 and database 130 according to a format associated with a selected database program. In this manner, designer 122 may create forms and a database in different formats to be compatible with different database programs.

After entering the information, user 20 may continue editing a database by selecting a “Next” button 238. The organization information entered or edited by user 20 in screen 216 is received from user 20, as indicated by step 512, and stored by server 100.

After the organization information is received, designer 122 causes a database design screen 240, shown in FIG. 2d, to be provided to user 20 as indicated in step 514. The database design screen 240 may be selected by clicking on the “Form Design” tab 241 or the “Next” button 238 from screen 216.

The database design screen 240 lists forms 242 stored in custom database information 123 that have been created for use with database 130. By selecting a form 242 from the list, sections 244 and fields 246 within that form 242 are displayed below the form 242 in screen 240 as shown. In addition, a sample layout 248 of the form 242 is shown. For example, in response to the “Central Intake” form 242 being selected, the “Demographics” and “Employment” sections 244 appear under the “Central Intake” form 242 icon and also appear in areas 250 and 252, respectively, in the sample layout 248. “First Name”, “Last Name”, “DOB”, “Address”, “City”, “State”, “Phone”, “Fax Number”, “Gender”, “Primary Language”, “Spoken Language”, “Client Picture”, “Physical Abuse Alleged”, and “Ethnicity” fields 246 appear under the “Demographics” section 244 icon and in the area 250. “Employer”, “Years Employed”, “Reasons Placed”, and “Test” fields 246 appear under the “Employment” section 244 icon and in the area 252. Changes to a form 242 may be saved by selecting a “Save” button 254. Forms 242 are stored on server 100 in custom database information 123.

Form 242, sections 244, and fields 246 are created and modified by right-clicking within screen 240 to bring up menu 256 and selecting either “Form Properties”, “Section Properties”, or “Field Properties”. The steps of providing and receiving form information, section information, and field information shown in steps 514, 516, 518, 520, 522, and 524 of FIG. 3a may be accomplished by selecting the “Form Properties”, “Section Properties”, and “Field Properties” from menu 256 as illustrated below.

To create a new form, user 20 selects “Form Properties” from menu 256 to cause window 262, shown in FIG. 2e, to appear. User 20 then selects a “New” tab 263 and enters a form name in a box 264. User 20 may select a form template or a blank form from a “Template” pull-down menu 266. Form templates listed in menu 266 include predefined sections and/or fields and are included in templates 124. User 20 selects a “Create New Form” button 268 to cause the new form to be created. Designer 122 causes the new form to be stored in custom database information 123 and to appear as a form 242 in the screen 240.

To modify an existing form, user 20 selects “Form Properties” from menu 256 to cause window 270, shown in FIG. 2f, to appear. User 20 then selects a “General” tab 271 and modifies a form name in a box 272, a form type with radio buttons 274, programs with which the form is associated using a “Programs” pull-down menu 276 and an “Add” button 278, and/or a taxonomy using a “Taxonomy” pull-down menu 282.

User 20 may select a form type as either a parent or a child using radio buttons 274. A parent form is a primary document around which the work of an agency associated with the database is centered. For example, a parent form may include demographic and general information about a client of an agency. A child form is a document used for a portion of the work of an agency to record interactions with a client. For example, a child form may include information associated with counseling sessions or services provided to a particular client of the agency.

The selected programs and taxonomy determine which programs a form is associated with and a location in a menu system where the form will appear in the programs page as shown in FIG. 4d and described herein below. User 20 selects a “Save Form” button 284 to cause designer 122 to save the form in custom database information 123 or a “Delete Form” button 286 to cause designer 122 to delete the form from custom database information 123.

To create a new section, user 20 selects “Section Properties” from menu 256 to cause window 290, shown in FIG. 2g, to appear. User 20 then selects a “New” tab 292 and enters a section name in a box 294. User 20 may select a section template or a blank section from a “Template” pull-down menu 296. Section templates listed in menu 296 include predefined fields and are included in templates 124. User 20 selects a form to add the new section to from a pull-down menu 298. User 20 selects a “Create New Section” button 299 to cause the new form to be created. Designer 122 causes the new form to be stored in custom database information 123 and to appear as a form 242 in the screen 240.

To modify an existing section, user 20 selects “Section Properties” from menu 256 to cause window 300, shown in FIG. 2h, to appear. User 20 then selects a “General” tab 301 and modifies a section name in a box 302 and/or a “Form Order” box 304. User 20 selects a “Save” button 306 to cause designer 122 to save the section in custom database information 123 or a “Delete” button 308 to cause designer 122 to delete the form from custom database information 123.

To create or modify a field, user 20 selects “Field Properties” from menu 256 to cause window 310, shown in FIG. 2i, to appear. User 20 then selects a “Data” tab 312 and enters or modifies a field name in a box 314, a label in a box 316, a data type in a pull-down menu 318, and/or an input type in a pull-down menu 320. Depending on the entries in menus 318 and 320, additional attributes will appear for user 20 to enter. For example, rows and columns may be entered in boxes 322, a maximum number of characters may be entered in a box 324, and check boxes 326 and/or 328 may be selected to indicate a key field or a required field, respectively. Display/tab order information may be entered in a box 330. User 20 causes a new field to be created from the entered field information by selecting a “New” button 332. User 20 may also causes a new field to be created from the entered or modified field information by selecting a “Copy” tab 340. User 20 causes the field information to be removed by designer 122 by selecting a “Remove” button 334 or saved by designer 122 by selecting a “Save” button 336. Designer 122 causes the new or modified field to be stored in custom database information 123.

Designer 122 also provides user 20 with an ability to program functions into a field. In response to user 20 selecting an “Open CodePad” button 338, designer 122 provides user 20 with a window 360, shown in FIG. 2k, to allow user 20 to write functions associated with the field. User 20 may select an event to trigger a function associated with the field in screen 350 shown in FIG. 2j. User 20 causes screen 350 to appear by selecting an “Event” tab 352. In screen 350, user 20 selects from a list of trigger events 354 and enters a function name in a box 356 associated with a desired trigger event 354. User 20 selects an “Open CodePad” button 358 to cause window 360, shown in FIG. 2k, to appear.

User 20 may enter functions as either client script to run on computer system 24 or server script to run on server 100. To enter client script, user 20 selects a “Client Script” tab 362 and enters the client script in a box 364. User 20 selects a “Save” button 366 to cause designer 122 to save the client script. User 20 selects a “Close” button 368 to cause designer 122 to close window 360. To enter server script, user 20 selects a “Client Script” tab 372 in a window 370, shown in FIG. 2l, and enters the server script in a box 374. User 20 selects a “Save” button 376 to cause designer 122 to save the server script. User 20 selects a “Close” button 378 to cause designer 122 to close window 370.

After user 20 finishes adding and modifying forms, sections, and fields for inclusion in pages 128 and database 130, user 20 selects a “Next” button 260, shown in FIG. 2d, to proceed to an “Admin password” screen 380, shown in FIG. 2m. User 20 may also select a “Previous” button 258, shown in FIG. 2d, to return to screen 216, shown in FIG. 2c.

Designer 122 provides user 20 with an ability to select security options for database 130 in screen 380 as indicated in step 526. Database 130 includes an administrator password. User 20 changes the administrator password by entering appropriate information into boxes 384 and selecting a “Set Password” button 386.

In response to user 20 selecting one or more security options in screen 380, designer 122 receives and stores the selections as indicated in step 528. User 20 navigates from screen 380 by selecting a “Previous” button 388 or a “Next” button 389.

Designer 122 provides user 20 with an ability to change graphical and other features of the custom database as shown in a screen 390 in FIG. 2n and indicated in step 530. In screen 390, user 20 selects an element of the custom database and a feature from a set of features associated with the element in an area 394. The element is displayed in a sample area 396 with the attributes associated with the selected feature. Sample area 396 displays a page, a folder, or a splash screen, for example, to aid user 20 in the customization process.

Table 1 herein below lists an example set of elements that designer 122 may allow user 20 to change.

TABLE 1

Bulletins: Article
Bulletins: Article Header
Bulletins: Background
Bulletins: Header
Client Folder: Client ID
Client Folder: Create-New Menu
Client Folder: Create-New Menu Bar
Client Folder: Create-New Menu Item
Client Folder: Create-New Menu Mouseover
Client Folder: Forms List
Client Folder: Forms List Column Header
Client Folder: Forms List Header
Client Folder: Forms List Mouseover
Client Folder: Program Button
Client Folder: Program Button Area
Client Folder: Program Button Mouseover
Client Folder: Program Button Selected
Client Folder: Workspace
Doc Search: Area Header
Doc Search: Button
Doc Search: Field Input
Doc Search: Field Label
Doc Search: Header
Doc Search: Info Background
Doc Search: Info Data
Doc Search: Info Label
Doc Search: Results Background
Doc Search: Results Header
Doc Search: Results List
Doc Search: Results List Mouseover
Doc Search: Workspace
Library: Background
Library: Field Background
Library: Field Label
Library: Reading
Library: Results Background
Library: Results List Heading
Library: Results List Item
Library: Results List Item Mouseover
Library: Text
Form Page: Field Input
Form Page: Field Input Background
Form Page: Field Label
Form Page: Page Buttons
Form Page: Page Header
Form Page: Page Workspace
Form Page: Section Header
Form Page: Section Workspace
Splash Page: Background
Splash Page: Image
Splash Page: Login Box
Splash Page: Login Box Button
Splash Page: Login Box Field
Splash Page: Login Box Label
Top Bar: Menu
Top Bar: Menu Bar
Top Bar: Menu Item
Top Bar: Menu Item Mouseover

Designer 122 receives and stores changes to the customization options in custom database information 123 as indicated in step 532. User 20 navigates from screen 390 by selecting a “Previous” button 398 or a “Next” button 399.

Subsequent to user 20 customizing database 130, designer 122 provides user 20 with a screen 400 as shown in FIG. 2o to allow user 20 to cause files to be generated for each form 242. User 20 may also navigate to screen 400 by selecting a “Generate Files” tab 402. Screen 400 lists forms 242 created and/or edited by user 20 in a table 402.

Table 404 includes the names of each form 242, a file name associated with each form 242, and a status associated with the file for each form. In the status column, the status “file exists” appears for a form 242 whose file has been generated previously and the status “ungenerated” appears for a form 242 whose file has not been generated.

User 20 selects one or more files to be generated by selecting one or more checkboxes 406 and selecting a “Generate Selected Files” button 407. In response to user 20 selecting files to be generated, designer 122 causes the selected files to be generated using custom database information 123 and stored on server 100 as pages 128 as shown in FIG. 1a and indicated in step 534. After the files have been generated, user 20 may access one or more files of pages 128 to manually edit the code contained therein. User 20 navigates from screen 400 by selecting a “Previous” button 408 or a “Next” button 409.

Additional details of the process of generating a custom database as performed by designer 122 are shown in FIG. 3b. Designer 122 creates directories at a location specified by a user as indicated in step 552. This step may be omitted where the directories for storing pages 128 and database 130 have already been created. Designer 122 then creates pages 128 using custom database information 123 and embedded functions (not shown) as indicated in step 554. The embedded functions are included as part of designer 122. Designer 122 adjusts these functions as needed according to custom database information 123. As noted above, the functions may include database, login, calendar, library, bulletins, navigation, and other administrative functions. Designer 122 causes the pages 128 to be stored in one or more of the directories as indicated in step 556. Designer 122 also causes database 130 to be created using custom database information 123 as indicated in step 558. Designer 122 causes database 130 to be stored in one or more of the directories as indicated in step 560.

Subsequent to a custom database being generated for user 20 as described hereinabove, user 20 accesses information stored in database 130 on server 100. Accordingly, server 100 provides information from database 130 to user 20 as indicated in step 536. In addition, user 20 provides additional information to be stored in database 130 on server 100 using pages 128. Accordingly, server 100 stores information from user 20 into database 130 as indicated in step 538.

FIGS. 4a through 4h illustrate an example of the use and operation of a custom database by user 20. User 20 accesses the custom database by accessing the location where the custom database is stored. For example, user 20 may enter a URL into a browser as described above. In response to the custom database being accessed, information is displayed to user 20 using to code and other information stored in pages 128. Pages 128 also provide user 20 with an ability to add, delete, and modify information in database 130. Further, pages 128 provide functions associated with database 130.

In FIG. 4a, a screen 600 illustrates a login screen provided to user 20 in response to user 20 attempting to access the custom database. To login, user 20 enters a login name into a box 602, enters a password into a box 604, and selects a “Login to Online Data Manager” button 606.

After user 20 is authenticated, user 20 is provided with a screen 610 as shown in FIG. 4b. Screen 610 includes one or more bulletins associated with an agency in a space 612. Screen 610 also includes a menu 614 for performing functions associated with the database. The functions shown in FIG. 4b include editing bulletins, form searching functions, administration functions, report functions, virtual office functions, and a logout function.

FIG. 4c illustrates a search screen 620 for searching the database. In screen 620, user 20 selects a category to search (e.g., First Name) using a pull down menu 622, enters a search term in a box 624, selects a number of results per page using a pull-down menu 626, and selects a “Search” button 628. The results of the search appear in a list 630. Information associated with a selected result appears in a box 632. User 20 begins a new search by changing the search information. A “New” button 634 allows user 20 to create a new parent form.

FIG. 4d illustrates a client folder screen 640. The programs of an agency are listed on client folder screen 640 as indicated by a bracket 642. User 20 selects a form from a menu 644 to add information to the database. The forms listed under menu 644 depend on the program 642 selected user 20.

In response to user 20 selecting a form from menu 644, a page screen 650 appears as illustrated in FIG. 4e. A “Central Intake” form 652 includes a “Demographics” section 654 and an “Employment” section 656. User 20 enters information into fields in sections 654 and 656 and selects a “Save” button 658 to cause the information to be saved. User 20 may also select a “Delete” button 660 to cause page 652 to be deleted and a “Close” button 664 to close page 652.

An access control screen 670 is illustrated in FIG. 4f. In screen 670, user 20 grants users of an agency access to one or more forms or reports in the database. User 20 selects a database element (e.g. a form, report, search screen, virtual office item, admin tool, etc.) from a scroll menu 672. User 20 selects a user from a list of users in a box 674 and double-clicks the user's name to add the user to a list of users with access to the database element in a box 678. User 20 selects a group from a list of groups in a box 676 and double-clicks the group name to add the group to a list of users with access to the database element in a box 678. User 20 revokes a user's access by selecting a user from the list in box 678 and double-clicking the user's name. In this way, user 20 grants and revokes rights to database elements for users within an agency.

A user management screen 680 is illustrated in FIG. 4g. To add a user to a user list in a box 682, user 20 enters information into fields 684, selects a group from a pull-down menu 686, and selects a “New” button 688. To remove a user from the user list, user 20 selects a user in the list and selects a “Remove” button 690. To modify information associated with a user, user 20 selects the user from the user list, enters information into fields 684, selects a group from a pull-down menu 686, and selects a “Save” button 692. User 20 selects a “Close” button 694 to exit user management screen 680.

A group management screen 700 is illustrated in FIG. 4h. To add a group to a group list in a box 706, user 20 enters a group name into a box 702 and additional information into a box 704 and selects a “New” button 708. To remove a group from the group list, user 20 selects a group in the list and selects a “Remove” button 710. To modify information associated with a group, user 20 selects the group from the group list, enters information into boxes 702 and 704 and selects a “Save” button 712. User 20 selects a “Close” button 714 to exit group management screen 700.

FIG. 4i illustrates an additional function that may be provided by code in pages 128. Pages 128 may include a library function to allow users of the database to share documents. A library screen 720 is shown in FIG. 4i. User 20 uploads a document to the library using a upload portion 722 of screen 720 by entering a name or title in a box 724, entering a file name in a box 726, indicating who the document is visible by in a box 728, entering a description in a box 730, and selecting an “Upload File” button 732. User 20 searches for a document in the library using a search portion 734 of screen 720 by entering search information in fields 736 and selecting a “Search” button 738. The search results appear in an area 740 of screen 720.

Pages 128 may also provide a report builder function (not shown). The report builder function allows user 20 to query data in database 130 and create reports. Pages 128 cause the created reports to be stored and provides an interface for users to choose filtering criteria before running the report (e.g. Date Ranges). The report builder function may be accessed by selecting a “Report Builder” link, button, or menu.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A system, comprising:
a computer system for:
through a network, providing a template to a user;
through the network, receiving a selection from the user of the template; and
generating a database including the template selected by the user.

2. The system of claim 1 wherein the template includes a predefined table.

3. The system of claim 1 wherein the template includes a predefined form.

4. The system of claim 1 wherein the template includes a predefined field.

5. The system of claim 1 wherein the template includes a predefined section.

6. The system of claim 5 wherein the predefined section includes a predefined field.

7. The system of claim 1 wherein the computer system is for:
in response to receiving a selection from the user, associating the template with a program associated with an agency.

8. The system of claim 1 wherein the computer system is for:
in response to receiving information associated with a form created by the user, generating the database including the form.

9. The system of claim 8 wherein the information associated with the form includes a field selected by the user.

10. The system of claim 9 wherein the information associated with the form includes an attribute associated with the field, and wherein the attribute is changeable by the user.

11. The system of claim 1 wherein the computer system is for:
receiving a change to the template from the user; and
generating the database including the change to the template.

12. The system of claim 1 wherein the computer system is for:
receiving login information from the user; and
authenticating the user using the login information prior to providing the template to the user.

13. A method, comprising:
through a network, providing a template to a user;
through the network, receiving a selection from the user of the template; and
generating a database including the template.

14. The method of claim 13 further comprising:
through the network, providing the template to the user, the template including a predefined table.

15. The method of claim 13 further comprising:
through the network, providing the template to the user, the template including a predefined form.

16. The method of claim 13 further comprising:
through the network, providing the template to the user, the template including a predefined field.

17. The method of claim 13 further comprising:
through the network, providing the template to the user, the template including a predefined section.

18. The method of claim 17 further comprising:
through the network, providing the template to the user, the template including the predefined section, and the predefined section including a predefined field.

19. The method of claim 13 further comprising:
in response to receiving a selection from the user, associating the template with a program associated with an agency.

20. The method of claim 13 further comprising:
in response to receiving information associated with a form created by the user, generating the database including the form.

21. The method of claim 20 wherein the information associated with the form includes a field selected by the user.

22. The method of claim 21 wherein the information associated with the form includes an attribute associated with the field, and wherein the attribute is changeable by the user.

23. The method of claim 13 further comprising:
receiving a change to the template from the user; and
generating the database including the change to the template.

24. The method of claim 13 further comprising:
receiving login information from the user; and
authenticating the user using the login information prior to providing the template to the user.

25. A computer program product, comprising:
a computer program processable by a computer system for causing the computer system to:
through a network, provide a template to a user;
through the network, receive a selection from the user of the template; and
generate a database including the template; and
an apparatus from which the computer program is accessible by the computer system.

26. The computer program product of claim 25 wherein the computer program is processable by the computer system for causing the computer system to:
through the network, provide the template to the user, the template including a predefined table.

27. The computer program product of claim 25 wherein the computer program is processable by the computer system for causing the computer system to:
through the network, provide the template to the user, the template including a predefined form.

28. The computer program product of claim 25 wherein the computer program is processable by the computer system for causing the computer system to:
through the network, provide the template to the user, the template including a predefined field.

29. The computer program product of claim 25 wherein the computer program is processable by the computer system for causing the computer system to:
through the network, provide the template to the user, the template including a predefined section.

30. The computer program product of claim 29 wherein the computer program is processable by the computer system for causing the computer system to:
through the network, provide the template to the user, the template including the predefined section, and the predefined section including a predefined field.

31. The computer program product of claim 25 wherein the computer program is processable by the computer system for causing the computer system to:
in response to receiving a selection from the user, associate the template with a program associated with an agency.

32. The computer program product of claim 25 wherein the computer program is processable by the computer system for causing the computer system to:
in response to receiving information associated with a form created by the user, generate the database including the form.

33. The computer program product of claim 32 wherein the information associated with the form includes a field selected by the user.

34. The computer program product of claim 33 wherein the information associated with the form includes an attribute associated with the field, and wherein the attribute is changeable by the user.

35. The computer program product of claim 25 wherein the computer program is processable by the computer system for causing the computer system to:
receive a change to the templates from the user; and
generate the database including the change to the template.

36. The computer program product of claim 25 wherein the computer program is processable by the computer system for causing the computer system to:
receive login information from the user; and
authenticate the user using the login information prior to providing the template to the user.
